(19) United States
(12) Patent Application Publication
(10) Pub. No.: US 2002/0024512 A1
(43) Pub. Date: Feb. 28, 2002

(54) Computer system

(76) Inventors: Michiyuki Terasawa, Iruma-shi (JP); Nobutaka Nakamura, Hidaka-shi (JP); Ken Kishida, Ome-shi (JP); Shinichi Furuta, Akishima-shi (JP); Hiroshi Nishibayahi, Ome-shi (JP); Tadayuki Matsubara, Tokyo (JP)

Correspondence Address: Finnegan, Henderson, Farabow,, Garrett & Dunner, L.L.P., 1300 I Street, N.W., Washington, DC, 20005-3315, US

(21) Appl. No.: 09/903,701

(22) Filed: Jul. 13, 2001

(30) Foreign Application Priority Data
Jul. 14, 2000 (JP) 2000-214740

(51) Int. Cl. G09G 5/00

(52) U.S. Cl. 345/204

(57) ABSTRACT

A computer system comprises a computer body that is attachable to a user's body. A projection port is formed in the outer surface of a housing of the computer body. The housing contains therein a display element that projects an image outward from the housing through the projection port. The housing further contains therein a vibration detecting element for detecting vibration of the computer body, a discriminating element for determining whether or not the computer body is moving, in accordance with a vibration pattern detected by means of the vibration detecting element, and a main control element adapted to stop the image display by means of the display element when it is concluded by the discriminating element that the computer body is moving.

### BACKGROUND OF THE INVENTION

1. Field of the Invention

The present invention relates to a computer system, and more specifically, to a computer system for use as a wearable computer that can be attached to a user's body when it is in service.

2. Description of the Related Art

With the recent progress in semiconductor technology, computer technology, etc., computers have been reduced in size and weight, and various portable computers of the notebook type, pocket type, etc. have been developed. Of late, moreover, wearable computers that can be attached to a user's body when in use have started to be developed.

A wearable computer comprises a computer body and a battery that can be attached to, for example, the waist of a user's body, a headset-type display element attachable to the user's head or a display element formed of a liquid crystal display device (LCD) attachable to an arm of the user, etc. The computer body and the display element are connected to each other by means of a cable. The computer body is provided with various controllers, memory, power source, etc. The headset-type display element is provided with a projector-type display element, headphones, microphone for voice input, etc. If the user wears the wearable computer on his/her body, he/she can, for example, repair high-technology devices handsfree with reference to design data displayed on the display element.

In the wearable computer constructed in this manner, however, the display element, whether the headset type or LCD, is formed independently of the computer body, so that it is troublesome to attach to or detach it from the user's body. In some cases, the user cannot attach or detach the display element by him/herself.

In the case where the LCD is used on the user's arm in the aforethe manner, it is less obstructive if it is smaller in size. In this case, however, the information content of the LCD as the display element is lower, and the display screen is too small to be visible. If the LCD is large-sized, in contrast with this, it inevitably hinders the motion of the user's body. In the case where the display element is of the headset type, it is attached to the user's head, so that it may obstruct the view to a certain degree, thereby hindering the job at hand.

In either case, moreover, connecting the display element and the computer body requires use of I/F circuits, connectors, etc., thus entailing an increase in size and weight of the individual components. Possibly, the display element and the computer body may be connected wirelessly. In this case, however, the connection additionally requires a radio circuit and the like, which increases the manufacturing cost increases inevitably.

Since the wearable computer is used on the user's body, on the other hand, an image displayed on the display element may sometimes interfere with vision whilst walking or running. Arrested by the displayed image, therefore, the user may possibly bump into or stumble over an object. While the user is walking or running, moreover, built-in devices in the computer body that include movable parts such as a hard disc drive (hereinafter referred to as HDD) may possibly be subjected to undue vibration or shock. In this case, there is a possibility of these devices wrongly operating or being damaged.

### BRIEF SUMMARY OF THE INVENTION

The present invention has been contrived in consideration of these circumstances, and an object of the invention is to provide a computer system capable of being easily attached to and detached from a user's body and ensuring improved mobility of the user's body when attached. Another object of the invention is to provide a computer system capable of improving the safety of a user in movement and the reliability of devices.

In order to achieve the above object, a computer system according to the present invention comprises a computer body attachable to a user's body, the computer body including a housing, a projection port in the outer surface of the housing, and a display element provided in the housing and used to project an image outward from the housing through the projection port.

In the computer system described above, the display element includes a transmission-type liquid crystal display device for displaying the image, a light source for applying light to the liquid crystal display device, an optical lens system opposed to the projection port and capable of outwardly emitting the light transmitted through the liquid crystal display device from the housing through the projection port, and a display controller for controlling the liquid crystal display device in accordance with imaging information.

According to the computer system constructed in this manner, the display element is located in the computer body, and an image projected from the display element is cast on a wall surface or screen so that the user can operate the computer body while watching the delineated image. Accordingly, the user need not separately wear an independent display element on his/her arm or head, so that the computer system can be easily attached to or detached from the user's body in a short time. At the same time, the number of devices to be attached to the user's body can be reduced, so that the mobility of the user's body can be improved, and the user's view can be cleared.

Further, the number of I/F circuits, connectors, etc. for connecting the computer body and the display element can be lessened, so that the individual devices can be reduced in size and weight, and the manufacturing cost can be lowered.

Another computer system according to the invention comprises a computer body attachable to a user's body, the computer body including a housing and a support portion supporting the housing on the user's body so as to be rockable around a given central axis.

According to the computer system constructed in this manner, the computer body can be oriented as required, depending on the working conditions, so that the operating efficiency can be improved.

Still another computer system according to the invention comprises a computer body attachable to a user's body and a display element for displaying an image in accordance with imaging information from the computer body, the computer body including a vibration detecting element for detecting vibration of the computer body, a discriminating element for determining whether or not the computer body is moving, in accordance with a vibration pattern detected by means of the vibration detecting element, and a main control element adapted to stop the image display by means of the display element when it is concluded by the discriminating element that the computer body is moving.

A further computer system according to the invention comprises a computer body attachable to a user's body, the computer body including a memory device having a movable portion and stored with an operating system, a vibration detecting element for detecting vibration of the computer body, a discriminating element for determining whether or not the computer body is moving, in accordance with a vibration pattern detected by means of the vibration detecting element, and a main control element adapted to stop the operation of the memory device when it is concluded by the discriminating element that the computer body is moving.

According to the computer system constructed in this manner, the main control element stops the operation of the display element or the image display by means of the display element when the user wearing or carrying the computer body is walking or running. Thus, there is no possibility of the user bumping into or stumbling over an object, distracted by the displayed image, so that safety can be improved.

According to the computer system constructed in this manner, moreover, the main control element stops the operation of the memory device when the user wearing or carrying the computer body is walking or running. If the computer body is subjected to undue vibration or shock while it is moving, therefore, the memory device can be prevented from wrongly operating or being damaged, so that the reliability of the devices can be improved.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a view showing a user wearing a computer system according to a first embodiment of the present invention;

FIG. 2 is a perspective view showing a computer body of the computer system;

FIG. 3 is a perspective view of the computer body from a different direction;

FIG. 4 is a cutaway front view of the computer body;

FIG. 5 is a perspective view showing the back side of the computer body;

FIG. 6 is a perspective view showing a modification of a belt attachment of the computer body;

FIG. 7 is a plan view schematically showing an HDD in the computer body;

FIG. 8 is a block diagram schematically showing an outline of the computer body;

FIG. 9 is a flowchart showing vibration detecting operation and HDD stopping operation in the computer system;

FIG. 10 is a perspective view showing a computer body of a computer system according to a second embodiment of the invention;

FIGS. 11A, 11B and 11C are an exploded perspective view showing the computer body of the computer system of the second embodiment, a plan view schematically showing an engaging portion; and a sectional view showing the engagement between a housing of the computer body and a support member, respectively;

FIG. 12 is a perspective view showing the computer body of the second embodiment oriented in direction;

FIG. 13 is a perspective view showing a modification of the computer body according to the second embodiment;

FIG. 14 is a perspective view showing a computer body of a computer system according to a third embodiment of the invention;

FIG. 15 is a perspective view showing the computer body with a screen portion of a projection unit in a drawn-out state, in the computer system of the third embodiment;

FIG. 16 is a perspective view showing a computer body and a projection unit of a computer system according to a fourth embodiment of the invention;

FIG. 17 is a perspective view showing a screen portion of a projection unit in a drawn-out state, in the computer system of the fourth embodiment;

FIG. 18 is a view showing the user wearing a computer system according to a fifth embodiment of the invention; and

FIG. 19 is a block diagram schematically showing an outline of a computer body of the computer system according to the fifth embodiment.

### DETAILED DESCRIPTION OF THE INVENTION

Computer systems according to several embodiments of the present invention will now be described in detail with reference to the accompanying drawings.

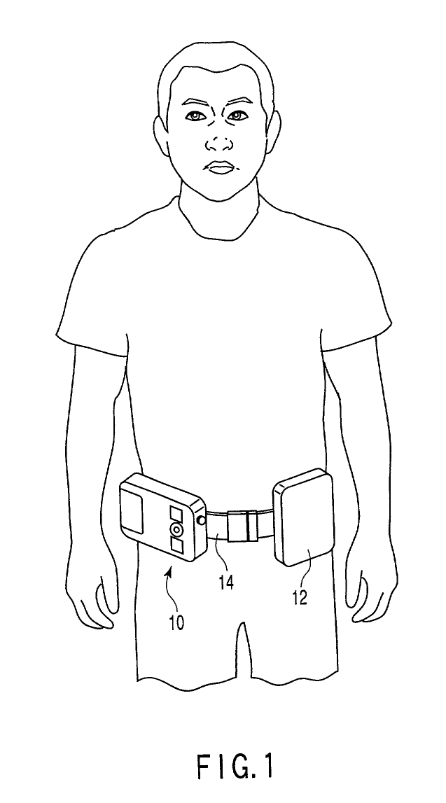

FIG. 1 shows a user wearing a computer system according to a first embodiment of the invention. This system comprises a computer body 10 and a battery 12. The computer body 10 and the battery 12 are attached to the waist of the user by means of a belt 14, for example, and are connected electrically to each other by means of a cable (not shown).

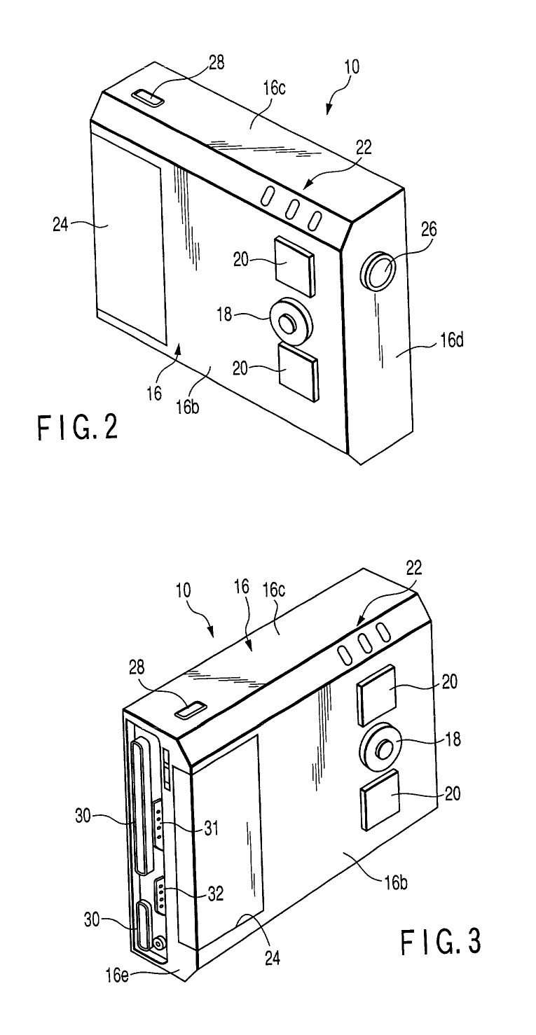

As shown in FIGS. 2 to 4, the computer body 10 is provided with a housing 16 of a synthetic resin or the like in the form of a substantially rectangular box. The housing 16 has a rear face 16a situated on the user's-body side, a front face 16b opposite to the rear face, a top face 16c, a first side face 16d, and a second side face 16e opposite to the first side face.

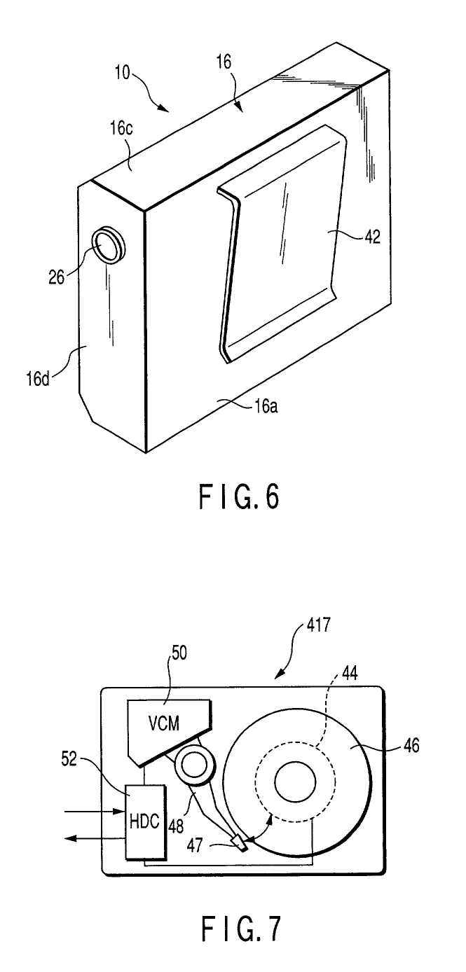

As shown in FIG. 5, a pair of belt keepers 40 for the belt 14, in the form of a metal rod each, are fixed to the rear face 16a of the housing 16. As shown in FIG. 6, a clip-shaped holder 42 on the rear face 16a of the housing 16 may be used as a structure for mounting the housing 16 on the belt 14.

As shown in FIGS. 2 to 4, a pointing device 18 and a pair of click switches 20 on the opposite sides of the pointing device are arranged, as an operating element for operating the computer body 10, on the front face 16b of the housing 16. Further, a plurality of FED's 22 for displaying operating states of the computer system, such as the on- or off-state of the power supply, operation of an HDD (mentioned later), etc., are provided in an intermediate portion between the front face 16b and the top face 16c of the housing 16. A PC card slot 24 is formed ranging from the front face 16b of the housing 16 to the second side face 16e. The slot 24 is closed by means of a slidable lid.

A projection port 26 is provided on the first side face 16d of the housing 16 that is directed substantially to the front of the user's body when the housing 16 is attached to the user's body. A power connector 31, a USB connector 32, and other connectors 30 including an expansion connector, DC adapter connector, etc. are arranged on the second side face 16e that is opposed to the first side face 16d. The battery 12 shown in FIG. 1 is connected to the power connector 31 by means of a cable and a connector (not shown). Further, the second side face 16e of the housing 16 is provided with a stop release switch 33 (mentioned later), and the top face 16c with a power switch 28.

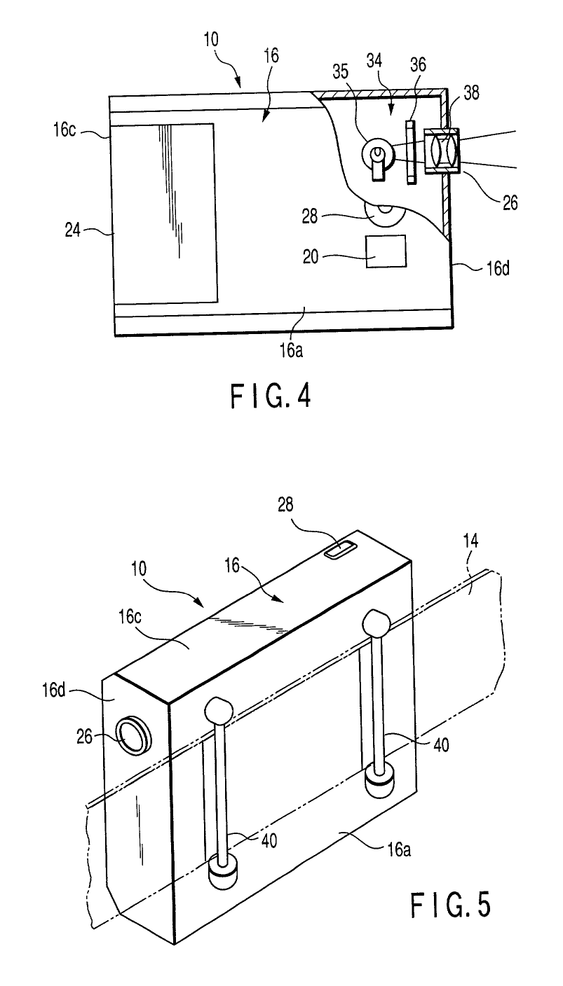

As shown in FIG. 4, the housing 16 contains therein a display element 34, which projects an image outward from the housing through the projection port 26. The display element 34 comprises a transmission-type liquid crystal display device (hereinafter referred to as an LCD) 36 for displaying the image, a light source 35 for applying light to the LCD, an optical lens system 38 for emitting the light transmitted through the LCD to the outside from the housing 16 through the projection port 26, and a display controller (mentioned later) for controlling the LCD in accordance with imaging information.

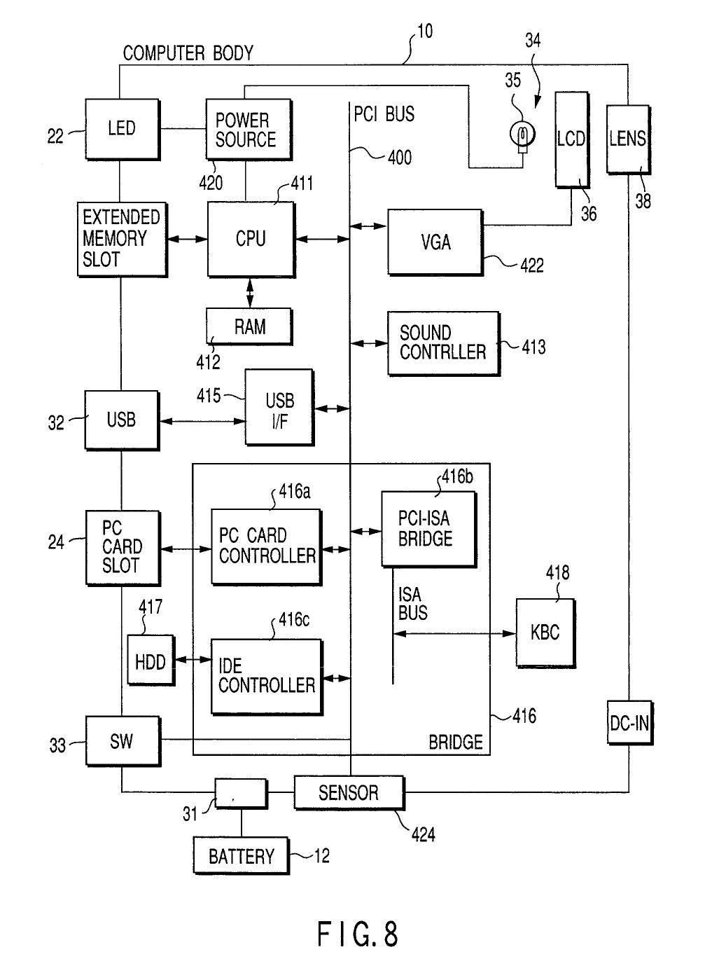

The following is a description of the internal structure of the computer body 10. As shown in FIG. 8, the housing 16 of the computer body 10 contains therein a PCI bus 400, CPU 411, video graphic adapter (VGA) 422 for use as the display controller, RAM 412, sound controller 413, USB controller 415, bridge 416, HDD 417 for use as a memory device, keyboard controller (KBC) 418, display element 34, vibration sensor 424, etc. As shown in FIG. 8, moreover, the bridge 416 contains therein a PC card controller 416a, PCI-ISA bridge 416b, IDE controller 416c, etc.

The CPU 411 doubles as a main control element and a discriminating element, and controls the entire computer system. The HDD 417 is stored with an operation system and various application programs that are to be executed by means of the CPU 411 and are loaded into the RAM 412. Further, the RAM 412 is stored with reference vibration pattern data that serve as criteria for the discrimination of the vibration state of the computer body 10, especially the vibration state of the computer body in movement.

The VGA 422, which serves to control the LCD 36 of the display element 34, supplies display data to the LCD in accordance with imaging information (coordinate data, imaging commands, etc.) from the CPU 411, thereby causing the LCD to display a desired image. Further, the light source 35 of the display element 34 is controlled by means of the CPU 411 through a power source 420. When the light source 35 is turned on with the desired image displayed on the LCD 36, the light emitted from the light source 35 and applied to the LCD is transmitted through the LCD, and then emitted outward from the housing 16 through the projection port 26 by means of the optical lens system 38. Thereupon, an image corresponding to the image displayed on the LCD 36 is projected outward from the housing 16 through the projection port 26, and cast on a wall or the like.

As shown in FIG. 7, on the other hand, the HDD 417 includes a magnetic disc 46 for use as a recording medium, a spindle motor 44 for rotating the magnetic disc, a magnetic head 47 for processing information on the magnetic disc, a voice coil motor (VCM) 50. The HDD 417 further includes a head actuator 48 for moving and positioning the magnetic head between an information processing position and a retreated position off the magnetic disc and a device control element (HDC) 52 for controlling the spindle motor, magnetic head, and VCM.

As shown in FIG. 8, moreover, the vibration sensor 424 that serves as a vibration detecting element detects vibration of the computer body 10 and delivers the pattern of the vibration to the CPU 411. If the CPU 411 concludes, in accordance with the detected vibration pattern, that the computer body 10 is moving or the user is walking or running, it stops the display operation of the display element 34.

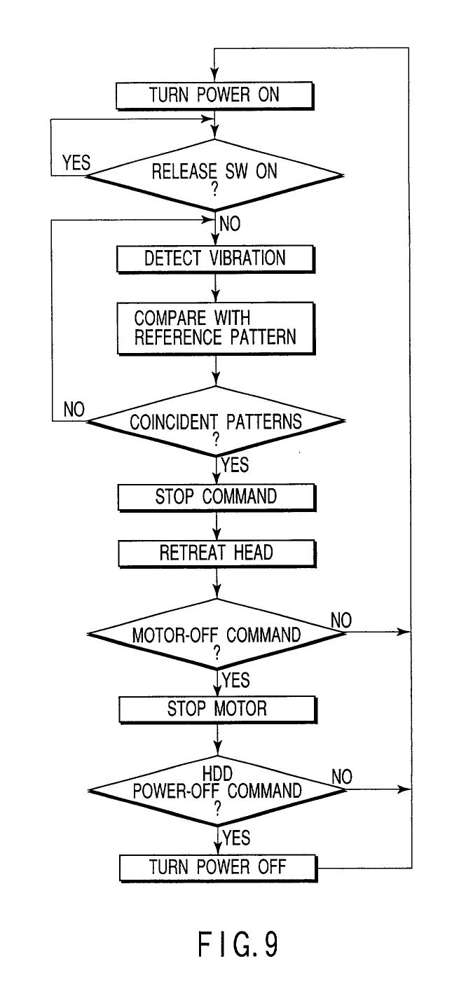

More specifically, when the power of the computer body 10 is switched on, as shown in FIG. 9, the CPU 411 causes the vibration sensor 424 to start detecting vibration of the computer body 10 if the stop release switch 33 is not on. Then, the CPU 411 compares the vibration pattern detected and delivered from the sensor 424 with a reference vibration pattern stored in the RAM 412. If the user is then walking or running, a continuous vibration is generated in the computer body 10. This continuous vibration pattern that indicates the computer body 10 in movement is stored in advance as the reference vibration pattern in the RAM 412, and is compared with the vibration pattern detected by means of the vibration sensor 424. If this comparison signifies that the two vibration patterns are substantially coincident, the CPU 411 can conclude that the computer body 10 is moving.

If it is concluded that the computer body 10 is moving, the CPU 411 delivers a stop command to the HDC 52 of the HDD 417. In response to this, the HDC 52 drives the VCM 50 to move and locate the magnetic head 47 in the retreated position. If a motor-off command is given, moreover, the HDC 52 stops the rotation of the spindle motor 44. Alternatively, the HDC 52 may be designed so that it can either retreat the magnetic head 47 or stop the rotation of the motor 44.

After the HDD 417 is stopped, the HDC 52 gives a declaration of stoppage completion to the CPU 411. If a power-off command for the HDD 417 is given from the CPU 411, in response to this, the HDC 52 cuts off the power supply to stop the HDD 417 completely. As the operation of the HDD 417 is stopped in this manner, the operation of the display element 34 also stops, so that the image display by means of the display element stops.

On the other hand, the user is expected to turn on the stop release switch 33 in advance in override limiting the stopping operation of the display element, in order to walk as he/she uses the computer system, for example. Thereupon, in this case, the CPU 411 causes the display element 34 to continue displaying the image without executing the vibration detection by means of the vibration sensor 424 or the stopping operation of the HDD 417.

If the CPU 411 concludes that the computer body 10 is moving, a declaration of movement completion may be given from the HDC 52 of the HDD 417 to the CPU 411 after the VCM 50 is spontaneously driven by means of the HDC 52 so that the magnetic head 47 is moved to and located in the retreated position.

According to the computer system of the present embodiment constructed in this manner, the display element 34 is located in the housing 16 of the computer body 10, and an image projected from the display element is cast on a wall surface or the like so that the user can operate the computer body while watching the delineated image. Accordingly, the user need not separately wear an independent display element on his/her arm or head, so that the computer system can be easily attached to or detached from the user's body in a short time. At the same time, the number of devices to be attached to the user's body can be reduced, so that the mobility of the user's body can be improved, and the user's view can be cleared. Further, the number of I/F circuits, connectors, etc. for connecting the computer body 10 and the display element 34 can be lessened, so that the individual devices can be reduced in size and weight, and the manufacturing cost can be lowered.

According to the computer system described above, moreover, the operation of the HDD 417 is suspended so that the image display by means of the display element 34 is stopped when the user wearing or carrying the computer body 10 is walking or running. Thus, there is no possibility of the user bumping against or stumbling over an object, distracted by the displayed image, so that safety can be improved. If the computer body 10 is subjected to undue vibration or shock while the user is walking or running, furthermore, the HDD 417 can be prevented from wrongly operating or being damaged, so that the reliability of the system can be improved.

Computer systems according to alternative embodiments of the invention will now be described in succession. In the description to follow, like reference numerals are used to designate like portions of the foregoing embodiment, and a detailed description of those portions is omitted.

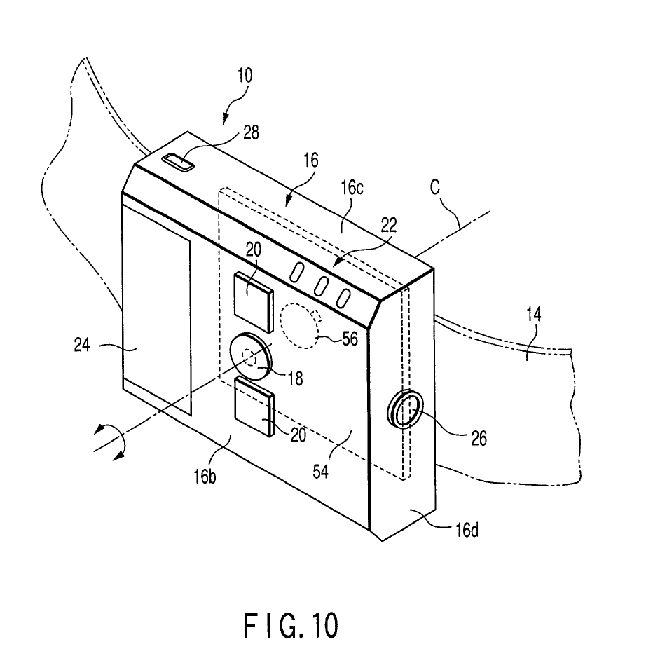

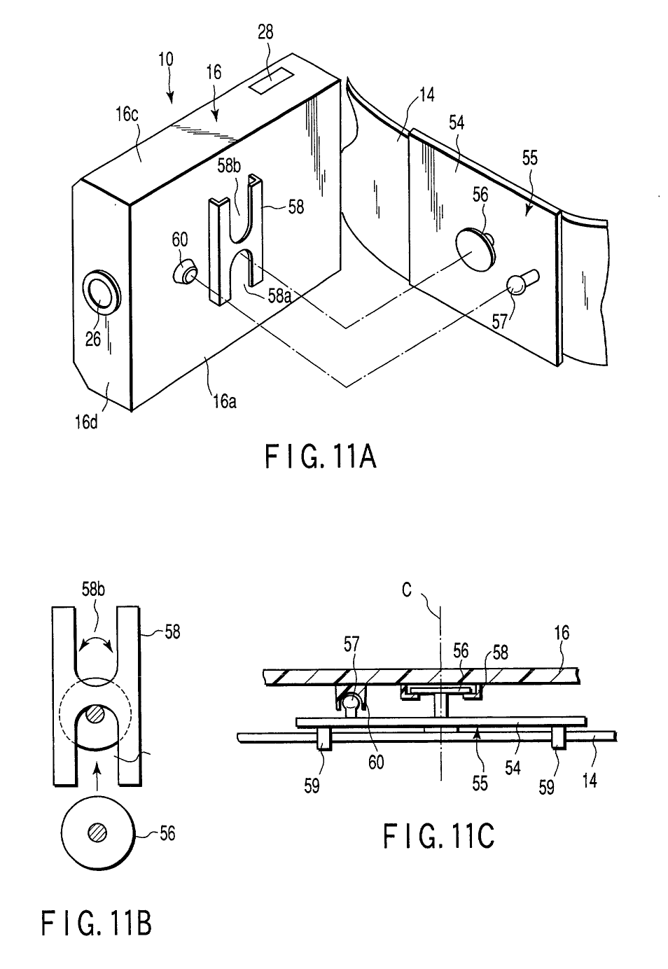

According to a second embodiment, as shown in FIGS. 10 and 11C, a housing 16 of a computer body 10 is attached to a belt 14 or the like by means of a support member 55, and can be supported on the user's body so as to be rockable around a given central axis C.

More specifically, the support member 55 includes a base plate 54 that is attached to the belt 14 by means of belt keepers 59. A support pin 56 and a fixing pin 57 protrude from the base plate 54. The support pin 56 is located substantially in the center of the base plate 54, and its distal end portion is in the form of a circular saucer. The fixing pin 57 is located beside the support pin 56, and its distal end portion is spherical.

Provided substantially in the center of a rear face 16a of the housing 16, on the other hand, is a bridge-shaped engaging member 58 that extends vertically, for example. The engaging member 58 defines a U-shaped first engaging slit 58a that opens downward and a U-shaped second engaging slit 58b that opens upward. On the rear face 16a, moreover, a recessed stopper 60 of an elastic material, such as rubber or synthetic resin, is fixed beside the engaging member 58.

The housing 16 is supported by means of the support member 55 and attached to the user's body in a manner such that the support pin 56 on the support member 55 is in engagement with the engaging slit 58a or 58b of the engaging member 58 and that the distal end portion of the fixing pin 57 is elastically fitted in the stopper 60.

In attaching the computer body 10 to the righthand side of the user's body, for example, the housing 16 is mounted on the support member 55 from above, and the support pin 56 is inserted into the first engaging slit 58a from below, as shown in FIG. 11B. Thereupon, the housing 16 is supported by means of the support pin 56 for rocking motion around the central axis C, that is, around the pin 56. As the fixing pin 57 is fitted into the stopper 60 of the housing 16, moreover, the computer body 10 is attached to the user's body without being allowed to rock.

In turning the computer body 10 around the user's body, the stopper 60 is disengaged from the fixing pin 57, whereupon the housing 16 is supported by means of the support pin 56 only. In this state, the user can rock the housing 16 around the support pin 56, thereby freely setting the direction of the housing 16 in accordance with the working conditions.

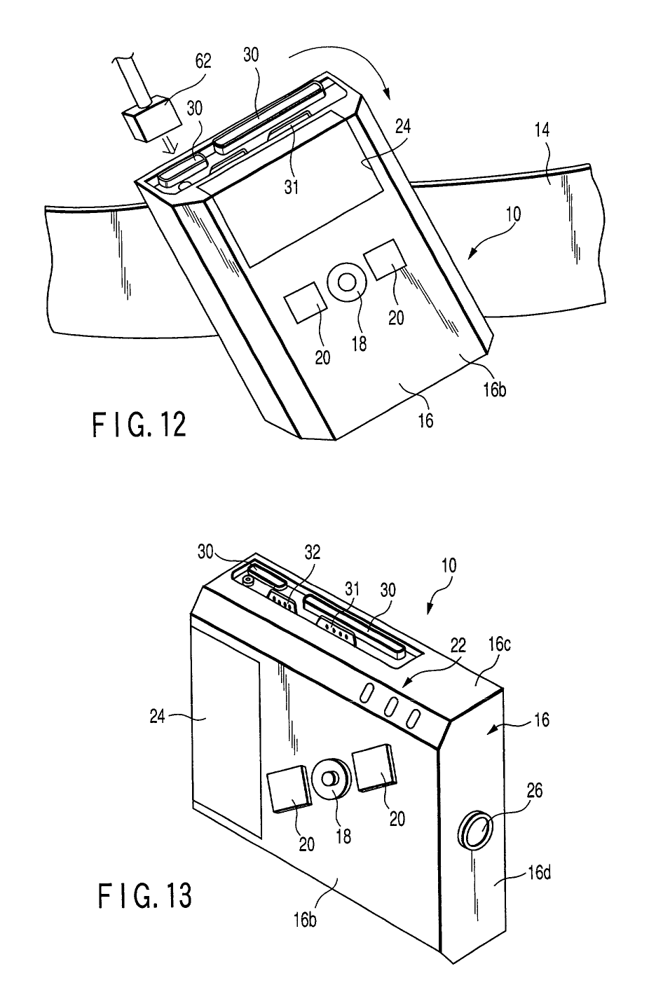

As shown in FIG. 12, for example, a connector 62 of a cable that is led out from a battery can be easily connected to a connector 30 of the computer body 10 by rocking the housing 16 so that a connector setting portion of the housing faces upward.

According to the second embodiment, moreover, a pointing device 18 for use as an operating element is located on the central axis C on a front face 16b of the housing 16. Further, a pair of click switches 20 are arranged side by side with the pointing device 18 in a direction perpendicular to the central axis C. If the housing 16 is rocked in either direction around the central axis C, with the operating element arranged in this manner, the operating efficiency of the pointing device 18 and the click switches 20 can be kept constant. Accordingly, the user can use the computer body 10 without being conscious of its vertical and horizontal orientations.

In attaching the computer body 10 to the left-hand side of the user's body, the support member 55 is attached to the belt 14 in a manner such that it is turned 180 degrees around the support pin 56, and the housing 16 is mounted on the support member 55 in a manner such that it is turned 180 degrees and that the support pin 56 is fitted in the second engaging slit 58b of the engaging member 58.

According to the second embodiment arranged in this manner, the same functions and effects of the foregoing first embodiment can be obtained. Besides, the computer body 10 can be freely rocked around the central axis C, so that the operating efficiency can be improved.

Although the pointing device 18 and the click switches 20 according to the second embodiment are arranged at right angles to a top face 16c of the housing 16, they may alternatively be arranged in the diagonal direction of the front face 16b, as shown in FIG. 13. Further, connectors 30, 31 and 32 of the computer body 10 may be provided on the top face 16c of the housing 16 instead of a second side face 16e of the housing. In this case, the user can enjoy a better view of the connectors 30, 31 and 32 with the computer body 10 on his/her body, so that the efficiency of the operation of connecting the connectors can be improved.

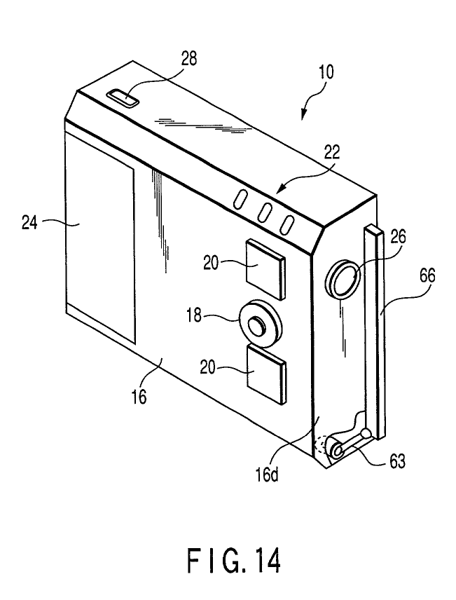

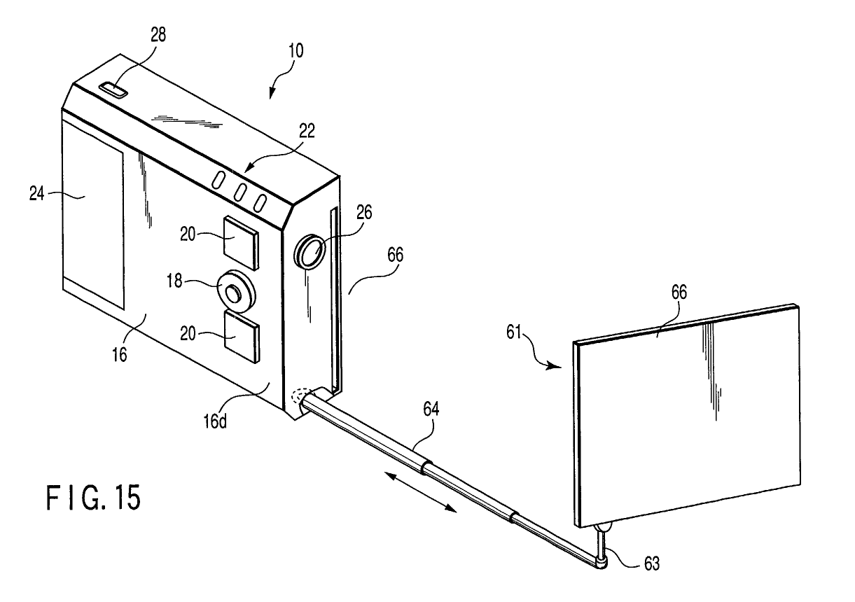

In the case where an image to be displayed is projected from the display element 34 in the computer body 10, as mentioned before, on the other hand, there may not be any wall surface or the like on which the image is cast, depending on the working conditions. According to a third embodiment shown in FIGS. 14 and 15, therefore, a computer body 10 is provided with a projection unit 61 that can display an image in such a situation.

The projection unit 61 includes a screen portion 66 on which an image projected from a projection port 26 of a housing 16 is cast and a support arm 64 for supporting the screen portion in a desired position. The support arm 64 is a telescopic structure, the proximal end of which is rockably connected to the base portion of the housing 16. Further, the screen portion 66 is rockably mounted on the distal end of the support arm 64 by means of a connecting arm 63. The screen portion 66 is a rectangular piece of plastic or cloth plate, the plane size of which is smaller than that of the housing 16.

Moreover, the housing 16 is formed having a rectangular slot 67 as a storage portion for storing the screen portion 66. The slot 67 opens in a first side face 16d of the housing and extends along the rear face of the housing.

When the screen portion 66 is not in operation, the support arm 64 is retracted and stored in the base portion of the housing 16, and the screen portion 66 is inserted into the slot 67 of the housing to be stored therein, as shown in FIG. 14.

In setting the screen portion 66 for use, the support arm 64 is extended as the screen portion 66 is drawn out of the slot 67 of the housing 16, as shown in FIG. 15. Then, an image can be watched in a manner such that the support arm 64 and the screen portion 66 are oriented as required and the image projected from the projection port 26 is cast on the screen portion.

According to the third embodiment arranged in this manner, an image projected from a display element 34 can be watched on the screen portion 66 without being influenced by the working environment of the computer system, so that the range of service of the computer system can be widened.

According to the third embodiment, the projection unit 61 may be removably mounted on the housing 16 so that it can be attached to the housing only if necessary. In this case, only the screen portion 66 may be removably mounted on the support arm 64. Further, the screen portion 66 need not always be regularly shaped, and may be of a fold-down type.

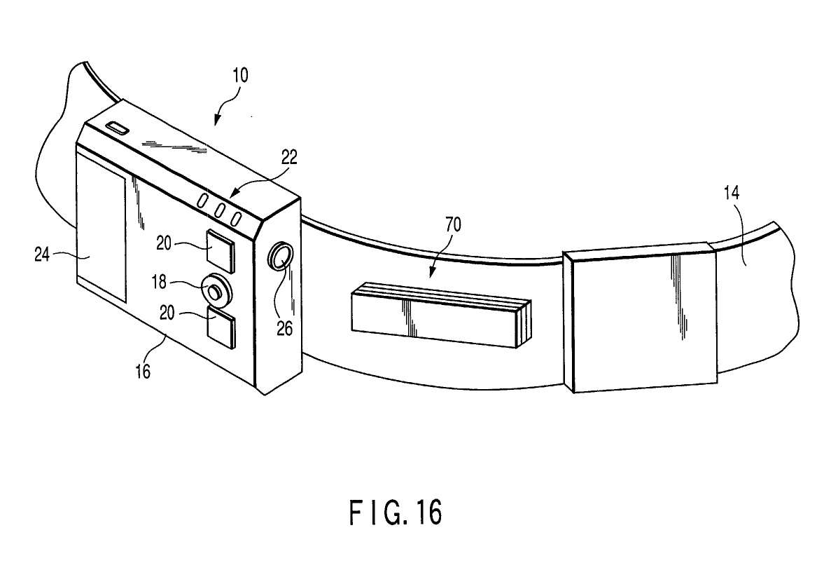

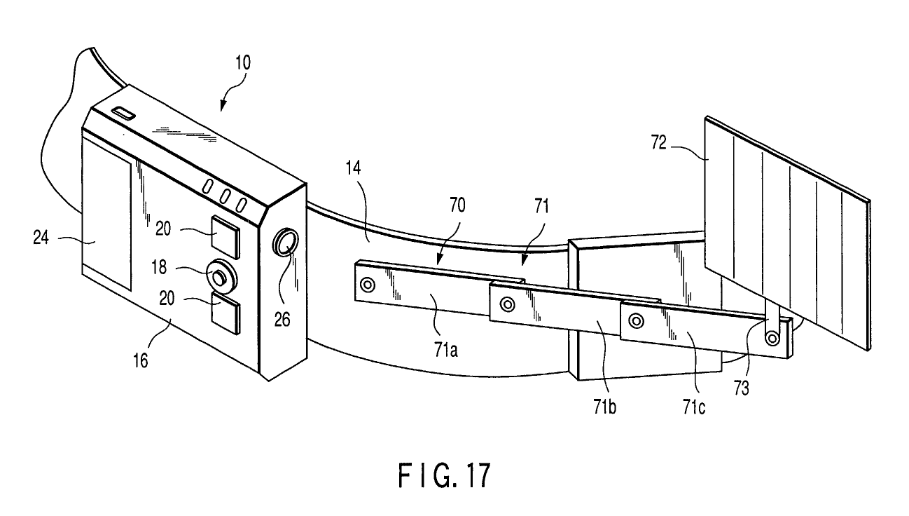

According to a fourth embodiment of the invention shown in FIGS. 16 and 17, the computer system is provided with a belt 14 as an auxiliary fixture for attaching a computer body 10 to the user's body. The belt 14 is fitted with a projection unit 70. The projection unit 70 includes a screen portion 72 on which an image projected from a projection port 26 of a housing 16 is cast and a support arm 71 for supporting the screen portion in a desired position. The support arm 71 is a telescopic or foldable structure including three arms 71a, 71b and 71c that are rockably connected to one another, for example. The proximal end of the support arm 71 is rockably attached to the belt 14. Further, the screen portion 72 is rockably mounted on the distal end of the support arm 71 by means of a connecting arm 73. The screen portion 72 is a rectangular plastic or cloth plate, and can be folded down substantially to the size (length and width) of each arm 71a, 71b or 71c.

When the screen portion 72 is not in operation, the support arm 71 and the screen portion 72 are kept folded lest they be obstructive, as shown in FIG. 16. In setting the screen portion 72 for use, the support arm 71 and the screen portion 72 are stretched and oriented as required, as shown in FIG. 17. Thereafter, an image can be watched in a manner such that the image projected from the projection port 26 is cast on the screen portion 72.

According to the fourth embodiment arranged in this manner, an image projected from a display element 34 can be watched on the screen portion 72 without being influenced by the working environment of the computer system, so that the range of service of the computer system can be widened. The auxiliary fixture is not limited to the belt, and may be any other suitable structure that can be attached to the user's body, e.g., a vest, sash, etc.

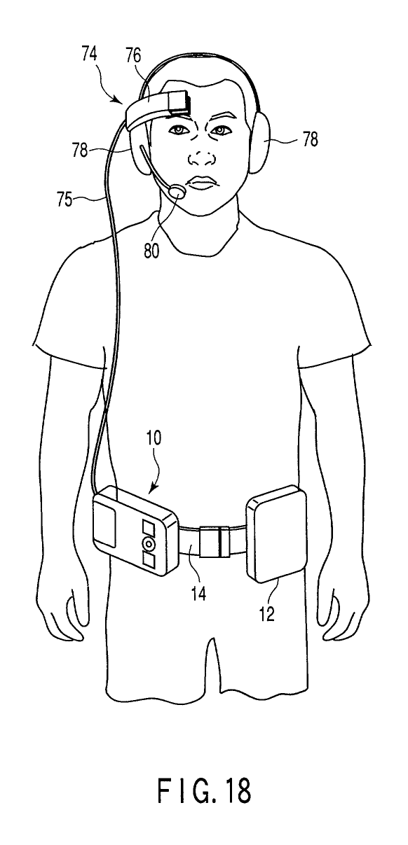

Although the display element is provided on the computer body according to any of the foregoing embodiments, it may alternatively be attached to a headset unit that is wearable on the user's head. More specifically, as shown in FIG. 18, the computer system according to a fifth embodiment of the invention comprises a computer body 10 and a battery 12, which are attached to the user's waist by means of a belt 14, for example, and a headset unit 74 attached to the user's head. The computer body 10 and the battery 12 are connected electrically to each other by means of a cable (not shown). The headset unit 74 is connected electrically to the computer body by means of a cable 75.

The headset unit 74 includes a pair of headphones 78, a microphone 80 for voice input, and a display element 76. The display element 76 includes a projector portion (not shown) for projecting an image and a screen portion (not shown) on which the projected image is cast. The screen portion is located in front of and diagonally above the user's eyes, for example.

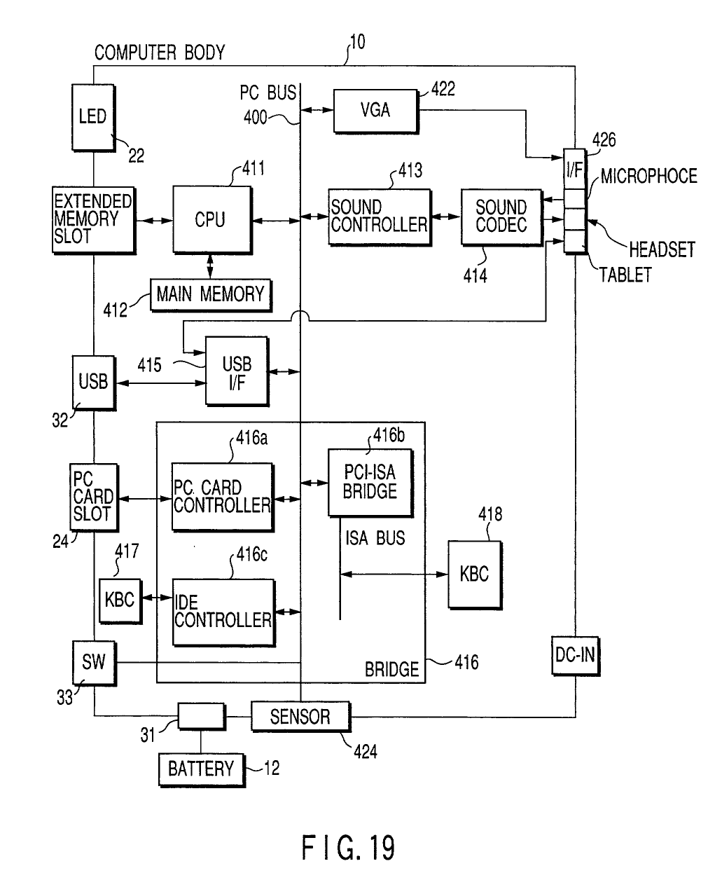

As shown in FIG. 19, on the other hand, the computer body 10 is provided with an interface (I/F) 426 for connecting the headset unit 74 and a sound CODEC 414, in place of the display element. For other configurations, the fifth embodiment resembles the first embodiment. The computer body 10 of the present embodiment is also provided with a vibration sensor 424 for detecting its vibration.

In the computer system constructed in this manner, as in the system of the first embodiment, the vibration of the computer body 10 is detected by means of the vibration sensor 424 during use. If it is concluded that the user is walking or running, the operation of an HDD 417 is suspended so that image display by means of the display element 76 is stopped. As in the case of the foregoing embodiments, therefore, there is no possibility of the user bumping into or stumbling over an object, distracted by the displayed image, so that safety can be improved. If the computer body 10 is subjected to undue vibration or shock while the user is walking or running, furthermore, the HDD 417 can be prevented from wrongly operating or being damaged, so that the reliability of the system can be improved.

According to the fifth embodiment, the computer body 10 need not always be attached to the user's waist, and may, for example, be used in a trouser pocket. The same functions and effects of the foregoing embodiments can be also obtained in this case.

It is to be understood that the present invention is not limited to the embodiments described above, and that various changes and modifications may be effected therein by one skilled in the art without departing from the scope or spirit of the invention. For example, the shape, dimensions, etc. of the housing of the computer body may be variously changed as required. Further, the location of the projection port in the housing of the computer body is not limited to the first side face of the housing and may be changed if necessary. Furthermore, the memory device of the computer body is not limited to an HDD, and may alternatively be a CD drive, DVD drive, etc.

Although the computer system according to each of the embodiments described herein is provided with the computer body, battery, or headset unit, moreover, it may be further provided with a keyboard that is wearable on an arm or the like, an LCD of a touch-panel type, etc.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computer system comprising:
a computer body attachable to a user's body, the computer body including a housing, a projection port in the outer surface of the housing, and a display element provided in the housing and configured to project an image outward from the housing through the projection port.

2. A computer system according to claim 1, wherein the display element includes a transmission-type liquid crystal display device for displaying the image, a light source for applying light to the liquid crystal display device, an optical lens system opposed to the projection port, for outwardly emitting the light transmitted through the liquid crystal display device from the housing through the projection port, and a display controller configured to control the liquid crystal display device in accordance with imaging information.

3. A computer system according to claim 1, which further comprises a projection unit attached to the computer body and including a screen portion on which the image projected from the projection port is cast.

4. A computer system according to claim 3, wherein the projection unit is removably mounted on the computer body.

5. A computer system according to claim 3, wherein the projection unit includes a telescopic support arm having one end connected to the housing and the other end connected to the screen portion.

6. A computer system according to claim 3, wherein the housing includes a storage portion for storing the projection unit.

7. A computer system according to claim 1, which further comprises an auxiliary fixture for attaching the computer body to the user's body and a projection unit attached to the auxiliary fixture and including a screen portion on which the image projected from the projection port is cast.

8. A computer system comprising a computer body attachable to a user's body, the computer body including a housing and a support portion supporting the housing on the user's body so as to be rockable around a given central axis.

9. A computer system according to claim 8, wherein the computer body includes an operating element provided on the outer surface of the housing, the operating element including a pointing device located on the central axis and click switches arranged side by side with the pointing device in a direction perpendicular to the central axis.

10. A computer system according to claim 9, wherein the housing has a rear face situated on the user's-body side, a front face opposite to the rear face and provided with the operating element, a top face, a first side face provided with the projection port, and a second side face opposite to the first side face, and the central axis extends substantially at right angles to the front face.

11. A computer system according to claim 10, wherein the computer body is provided with a connector on the second side face of the housing.

12. A computer system according to claim 10, wherein the computer body is provided with a connector on the top face of the housing.

13. A computer system comprising:
a computer body attachable to a user's body; and
a display element for displaying an image in accordance with imaging information from the computer body,
the computer body including a vibration detecting element for detecting vibration of the computer body, a discriminating element for determining whether or not the computer body is moving, in accordance with a vibration pattern detected by means of the vibration detecting element, and a main control element adapted to stop the image display by means of the display element when it is concluded by the discriminating element that the computer body is moving.

14. A computer system comprising a computer body attachable to a user's body, the computer body including a memory device having a movable part and stored with an operating system, a vibration detecting element for detecting vibration of the computer body, a discriminating element for determining whether or not the computer body is moving, in accordance with a vibration pattern detected by means of the vibration detecting element, and a main control element configured to stop the operation of the memory device when it is concluded by the discriminating element that the computer body is moving.

15. A computer system according to claim 14, wherein the memory device includes a disc-shaped record medium, a motor for rotating the record medium, a head for processing information on the record medium, a head actuator for moving and positioning the head between an information processing position and a retreated position off the record medium, and a power supply element, and the main control element is configured to move the head to the retreated position, stop the motor, and/or cut off the power supply element when it is concluded by the discriminating element that the computer body is moving.

16. A computer system according to claim 14, wherein the memory device includes a disc-shaped record medium, a motor for rotating the record medium, a head for processing information on the record medium, a head actuator for moving and positioning the head between an information processing position and a retreated position off the record medium, a device control element for controlling the motor, head, and head actuator, and a power supply element, the device control element being configured to move the head to the retreat position and inform the main control element of completion of head movement when it is concluded by the discriminating element that the computer body is moving.
